(19) United States
(12) Patent Application Publication
(10) Pub. No.: US 2024/0246357 A1
(43) Pub. Date: Jul. 25, 2024

(54) SPOKE REINFORCING METHOD AND REINFORCED STRUCTURE OF SPOKES

(71) Applicant: HEXA CO., LTD., Taipei City (TW)

(72) Inventor: James Chen, Taipei City (TW)

(21) Appl. No.: 18/157,840

(22) Filed: Jan. 22, 2023

(51) Int. Cl. B60B 1/02

(52) U.S. Cl. CPC B60B 1/0246

(57) ABSTRACT

The present invention relates generally to a spoke reinforcing method and reinforced structure of spokes, the method includes a main body of spoke with a head end and a thread part on two ends respectively, a neck is disposed below the head end, the neck is forged at least twice to enlarge the cross-section area of the neck, and to increase the density and strength of the metal grains therein; a hexagonal columnar reinforced structure is forged below this high density neck, and the high frequency lateral stress on the lower part of the high density neck is buffered by the optimal compressive strength and flexural strength of the hexagonal column, the reinforced structure of spokes produced by this method can reduce the spoke fracture probability and prolong the spoke lifetime.

### BACKGROUND OF INVENTION

### 1. Field of the Invention

The present invention relates generally to a spoke reinforcing method and manufacturing spokes with a reinforced structure, and more particularly to a spoke reinforcing method and reinforced structure of spokes which can enhance the compressive strength and flexural strength, reduce the fracture probability, and prolong the lifetime of spokes.

### 2. Description of Related Art

As shown in FIG. 1, a conventional spoke (6) has a main body of spoke, a head (61) and a thread part (62) are disposed at the two ends of the main body of spoke respectively, and a curved neck (63) is formed at the joint of the head (61) and the main body of spoke; as the neck fracture often occurred in the implementation of conventional spokes, the suppliers made improvement and developed an improved spoke (7), as shown in FIG. 2, besides the head (71), thread part (72) and neck (73) of basic structure of said spoke, a forge processing method to forge the neck (73) of the main body of spoke at least twice is proposed, so as to remedy the frequent neck (63) fracture of conventional spoke (6). This improved spoke performed successfully in tensile test and fatigue test, the laboratory data were satisfactory. However, noncausal fracture occasionally occurred in practice, the ruptures were almost all in the spokes on the non-driving side (N) of the rear wheel. This is a fatal defect, and the fractured spoke would seize the wheel, which may injure the rider. However, it is abnormal that the spokes on the non-driving side (N) fracture first, so it is low-tension end (low stress end). According to experience, the spokes on the driving side (D) receiving high tension, high pull and high torque are supposed to fracture first in practice, as shown in FIG. 3. The “tensile test” and “anti-fatigue test” were performed repeatedly throughout the years, this kind of reinforced spokes still resulted in good data, and the fracture could not be concluded but handled according to uncertain reasons.

Why did the improved spoke (7) has good laboratory data, but the fracture occurred continuously? The analysis result showed the laboratory test method had blind spots. In the tensile test (FIG. 4) and fatigue test (FIG. 5) for the conventional improved spoke (7), the stress was applied vertically. However, the wheelset not only receives vertical force, but also receives lateral force in the wheel assembling process or in practical application. Moreover, the spoke is located between the hub and rim, and there is a tilt angle. In order to obtain more accurate experiment data, the test method needs to be changed. The assembly method for the wheel with different angles on both sides is simulated, different hubs are provided with different wheel diameters, a 4°˜10° bevel angle is generated between the improved spoke and hub (about 4° on the rear wheel driving side of 26″ bicycle, about 10° on non-driving side). The tensile tester and fatigue tester are changed from standard vertical angle to tilt angle for retest, in the novel tensile test, the test results of “tilt angle” and “standard vertical angle” are compared, there is slight variation in the tensile figure of the improved spoke. The tensile figure is reduced only by 1˜2% when the improved spoke has a 10° tilt angle (FIG. 6). However, in the novel fatigue test, the test results of “tilt angle” and “standard vertical angle” are compared (FIG. 7), there is significant variation in the lifetime of spokes. The spoke with a tilt angle is more likely to fracture. When the spoke has a 10° tilt angle, the fatigue test shows the lifetime is shortened by almost 50%. It is obvious that this improved spoke processing method may be favorable for the low speed but high load vehicle type (the spokes of this process have high tensile figure), but there is a high fracture risk for high speed vehicle type (the spokes of this process are adverse to high frequency vibration fatigue). Without improvement, the improved spokes produced by this processing method would keep causing accidents.

To further probe into this problem, according to the running test and fatigue test, the breaking points of the conventional improved spoke mostly occur within 3 mm normally under the forging reinforced area. However, after the wheelset is assembled and the improved spoke has normal tension, the shape of conventional improved spoke is observed, there is bending due to stress (direction of stress changed) at 1˜5 mm normally under the forging reinforced area. This bending point due to stress is exactly the position where the bending stress is concentrated, as well as the breaking point (B) in the fatigue test result (FIG. 8). This breaking point (B) shows that the neck of the conventional improved spoke is reinforced by forge processing, the work hardening keeps its shape (approximating steel body), the direction of lower stress is changed on the contrary, the lateral force results in deformation, and the fatigue hot zone/fracture hot zone is formed in high-frequency vibration. This fatigue hot zone/fracture hot zone is resulted from inconsistent metal density and grain boundary interface with faults and excessive difference in the juncture of forging reinforced area and non-forged area of the improved spoke (FIG. 9), so that the bending stress is concentrated in the non-forged area with lower metal density, and the anti-fatigue lifetime is shortened.

In view of this, the inventor of this project sought for a solution, with years' expertise and experience in manufacturing spokes, through continuous experiments, trials and improvement, the spoke reinforcing method and reinforced structure of spokes of the present invention were achieved, so as to enhance industrial competitiveness and added value.

### SUMMARY OF THE INVENTION

The objective of the present invention is to provide a spoke reinforcing method and reinforced structure of spokes, and an improvement engineering is proposed for the deficiencies in conventional spokes even reinforced improved spokes, in the fracture hot zone of the general/improved spoke, a hexagonal columnar reinforced section is forged according to correct procedure to substitute the original cylindrical structure. The fatigue fracture hot zone of spoke is evaded positively, so as to obtain the optimal compressive strength and flexural strength, and the fracture probability of the fatigue fracture hot zone is reduced, the spoke lifetime is prolonged.

In order to achieve said purpose, the present invention provides a spoke reinforcing method, including straightening and cutoff, the drawn unprocessed spoke is straightened and cut to the required length; first forging, one end of the spoke is stamped by a first stamping unit to form the initial head and neck; clamp forming, the head, neck and main body of the initial formed spoke are clamped by a clamping die, the shape of the reinforced part is forged during clamping; second forging, said spoke fixed by the same clamping die is stamped by a second stamping unit, so as to form a reinforced structure of spokes with a head, a neck and a reinforced part; hobbing, the end opposite to the head of said spoke is hobbed to form the thread part.

In an embodiment, a bending step can be created between the second forging and hobbing steps to bend the neck of the formed spoke.

A reinforced structure of spokes is manufactured according to said spoke reinforcing method, the spoke includes a main body of spoke, a head, a neck and a reinforced part are disposed in turn from the edge of one end of the main body of spoke, the other end is provided with a thread part.

In an embodiment, the length of the reinforced part of the reinforced structure of spokes is at least 5 mm.

In an embodiment, the cross-sectional shape of the reinforced part is any one of polygons.

In an embodiment, the cross-sectional shape of the reinforced part is hexagonal.

In an embodiment, the cross-sectional shape of the reinforced part is rectangular.

In an embodiment, the spoke forms include straight-pull spoke and elbow spoke.

### BRIEF DESCRIPTION OF THE DRAWINGS

FIG. 1 is the outside view of a conventional spoke.

FIG. 2 is the outside view of a conventional reinforced spoke.

FIG. 3 is the schematic diagram of conventional improved spokes installed on wheel.

FIG. 4 is the schematic diagram of tensile test for conventional improved spoke.

FIG. 5 is the schematic diagram of fatigue test for conventional improved spoke.

FIG. 6 is the schematic diagram of tensile test for conventional improved spoke with improved tilt angle.

FIG. 7 is the schematic diagram of fatigue test for conventional improved spoke with improved tilt angle.

FIG. 8 is the schematic diagram of rupture of conventional improved spoke.

FIG. 9 is the schematic diagram of grain density of conventional improved spoke.

FIG. 10 is the outside view from different viewing angles of the reinforced structure of spokes of the present invention.

FIG. 11 (A) (B) show the flow charts of the present invention for different spokes.

FIG. 12 (A) (B) are the actual process diagrams I and II of the spoke reinforcing method for different spokes of the present invention.

FIG. 13 is the implementation application illustration of the spoke reinforcing method of the present invention.

FIG. 14 is the schematic diagram of grain density of the reinforced structure of spokes of the present invention.

FIG. 15 shows the fatigue test results of the reinforced structure of spokes of the present invention, conventional spoke and conventional improved spoke at different tilt angles.

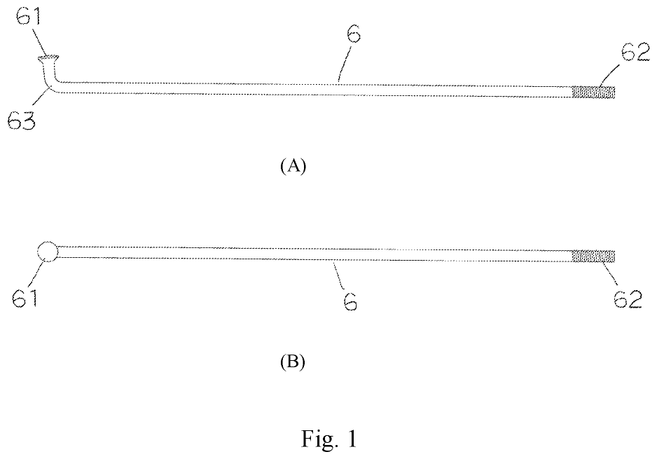

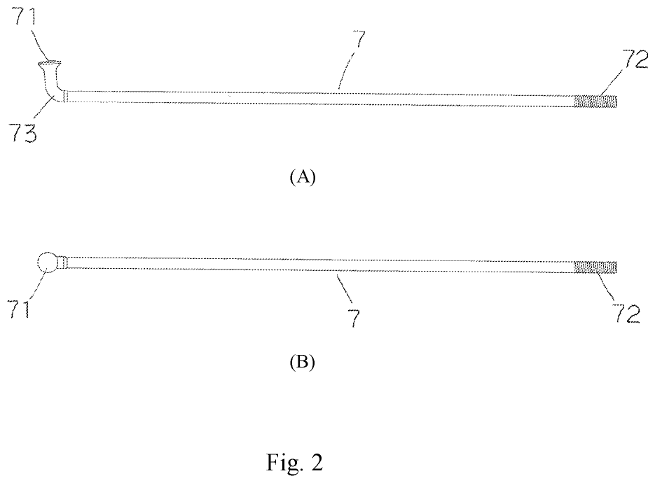

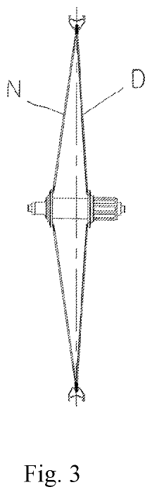

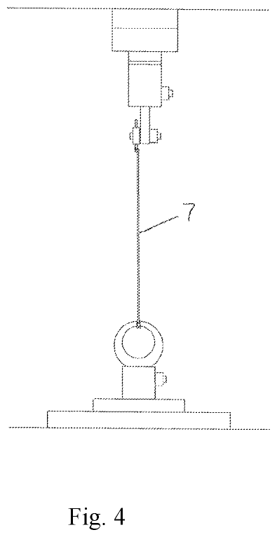

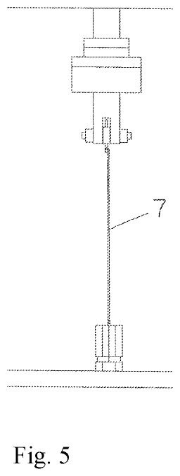

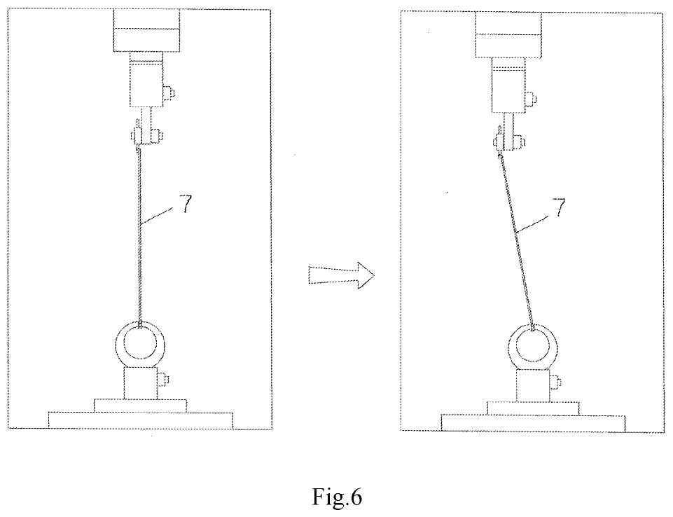

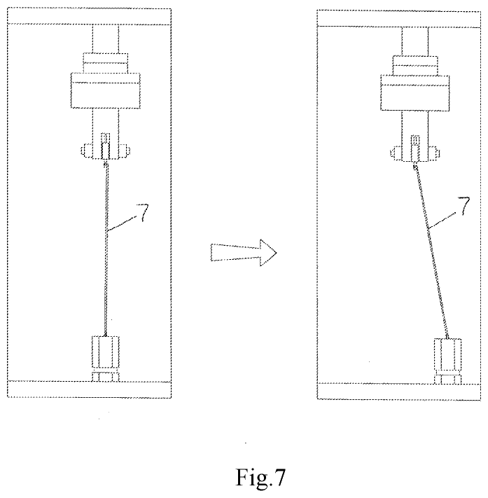

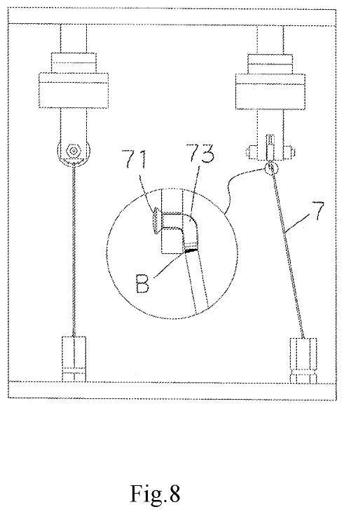

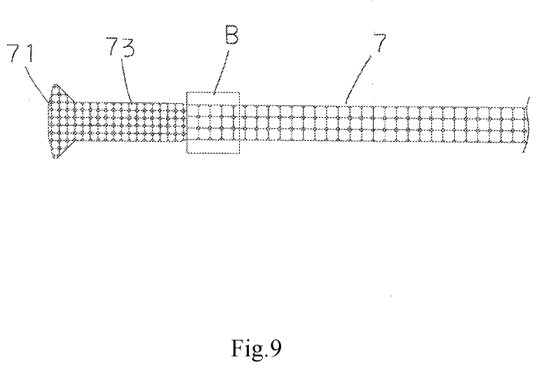

### DETAILED DESCRIPTION OF THE INVENTION

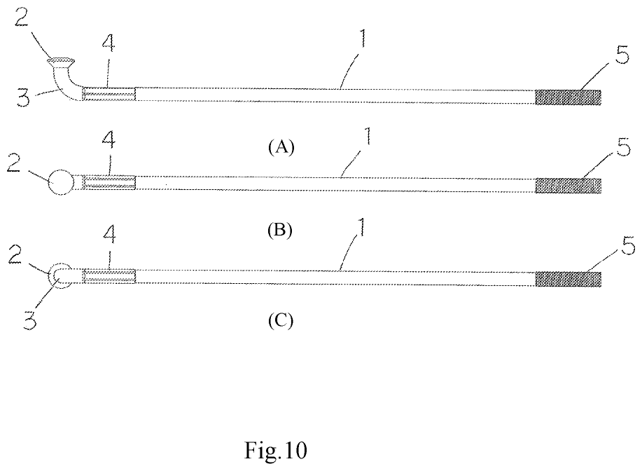

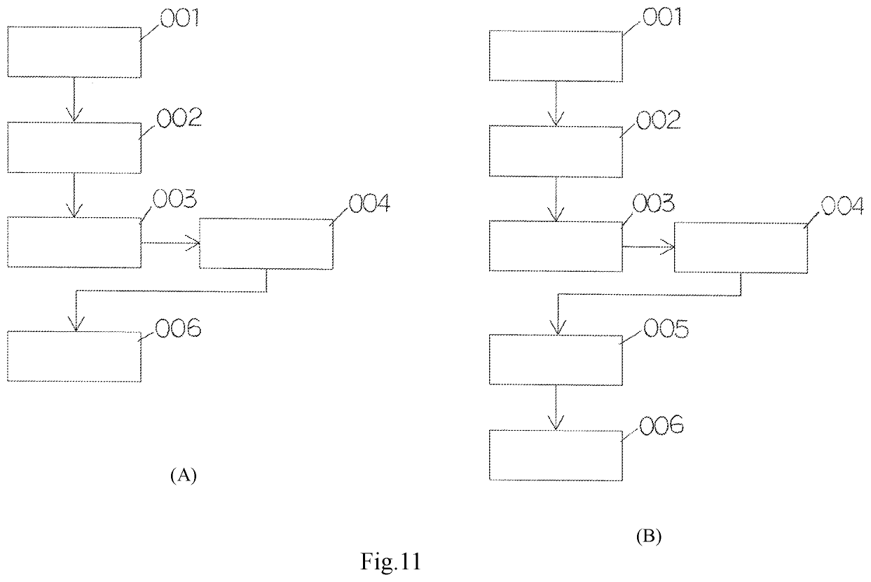

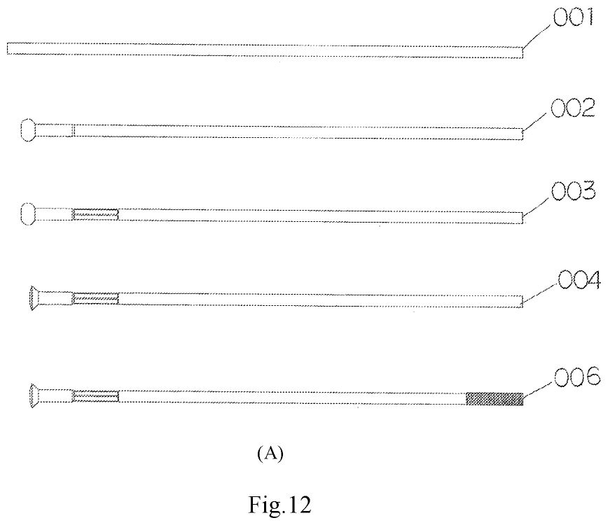

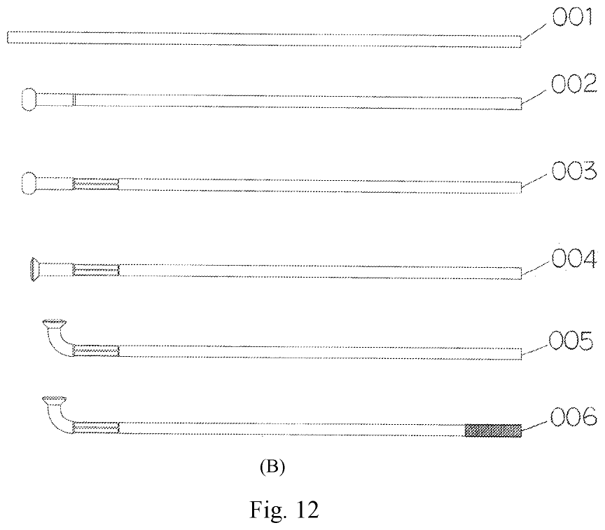

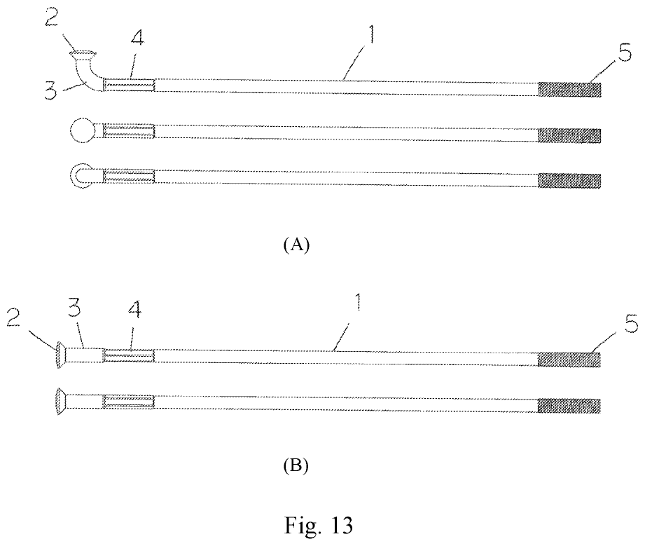

FIGS. 10˜14 disclose the spoke reinforcing method in a preferred embodiment of the present invention. First, a metal material is drawn into an elbow spoke of the required diameter. The metal material includes, but not limited to stainless steel, carbon steel, titanium alloy, aluminum alloy, etc. The spoke production methods include straight-pull spoke and elbow spoke, taking the elbow spoke production method as an example, as shown in FIG. 11 (B), the procedure includes straightening and cutoff (001), the drawn spoke (1) is straightened and cut to the required length; first forging (002), one end of the spoke (1) is stamped by a first stamping unit to form the initial head (2) and neck (3); clamp forming (003), the head (2), neck (3) and main body of spoke (1) of the initial formed spoke (1) are clamped by a clamping die, the shape forging of the reinforced part (4) is completed during clamping, a hexagonal column is taken as an example in this embodiment (including, but not limited to triangular prism, quadrangular prism or arbitrary polygonal column); second forging (004), the spoke (1) clamped by the clamping die is stamped by a second stamping unit, so as to form the final head (2), neck (3) and reinforced part (4); bending (005), the neck (3) of the formed spoke (1) is bent; hobbing (006), the end opposite to the head (2) of said spoke (1) is hobbed to form a thread part (5), thus reinforced structure of spokes is completed, as shown in FIG. 10.

The straight-pull spoke production method is shown in FIG. 11 (A), the procedure is free of the bending (005) process, including straightening and cutoff (001), first forging (002), clamp forming (003), second forging (004) and hobbing (006).

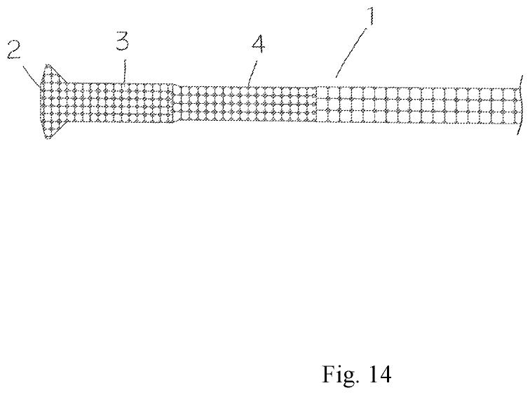

The clamp forming (003) in said reinforced spoke manufacturing method includes the second forging (004) process. It is noteworthy that the neck (3) and reinforced part (4) of the spoke (1) must be forged in the same clamping die, so as to make sure the grain density of the processed head (2), neck (3) and reinforced part (4) of the spoke (1) is continuous and unfaulted, as shown in FIG. 14.

As shown in FIG. 10, the reinforced structure of spokes manufactured according to said spoke reinforcing method includes a main body of spoke (1), a head (2), a neck (3) and a reinforced part (4) are arranged in turn from the edge of one end of the main body of the spoke (1), the other end is provided with a thread part (5). Particularly, the cross-sectional shape of the reinforced part (4) is hexagonal (or rectangular and a polygonal) structure type, and it is experimentally proved that the optimal compressive strength and flexural strength can be achieved using minimum quantity of materials.

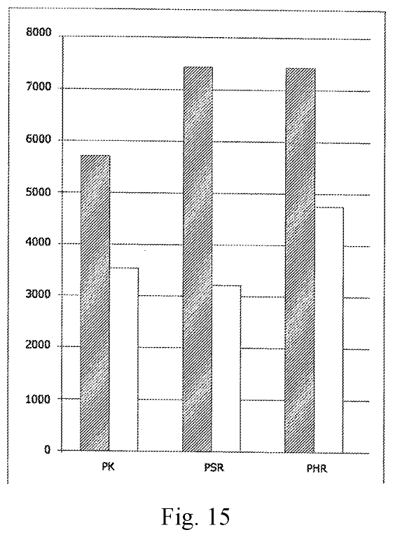

FIG. 15 discloses the fatigue test results of the spoke of the present invention, conventional spoke and conventional improved spoke; the left side is the fatigue test (times), the lower PK represents conventional spoke, PSR represents the improved spoke, PHR is the reinforced structure of spokes of the present invention, the left side of each histogram is 0° (standard vertical fatigue test), the right side is 10° (tilt angle fatigue test), in the same test condition, the same raw material, the same production equipment, the same test equipment and the same fixture are used to perform fatigue test (180 Kgf, 10 Hz) for the conventional spoke, improved spoke and reinforced structure of spokes; it is observed in the chart that the data of the reinforced structure of spokes of the present invention have better performance than conventional spoke and conventional improved spoke in 0° (standard vertical fatigue test) or 10° (tilt angle fatigue test). The experiment data prove that the spoke strength can be improved greatly after the fragile part of the conventional improved spoke is improved into a hexagonal columnar reinforced part structure type according to the correct processing procedure.

According to the above description, the spoke reinforcing method of the present invention proposes forging a reinforced part (hexagonal columnar or rectangular) connected to the forged neck, because the area 1˜3 mm below the neck thickened by multiple times of forge processing will become the fatigue/fracture hot zone, so as to substitute the unforged cylindrical spoke at the conventional joint, the reinforced part in this shape has the best compressive strength and flexural strength, so as to buffer the high frequency lateral stress on the joint below the neck of high density grains, and to improve the endless fracture accidents, meanwhile the spoke fracture probability is reduced, and the spoke lifetime is prolonged.

Although the invention has been explained in relation to its preferred embodiment, it is to be understood that many other possible modifications and variations can be made without departing from the spirit and scope of the invention as hereinafter claimed.

1. A spoke reinforcing method, including the following steps:
straightening and cutoff, the drawn spoke is straightened and cut to the required length;
first forging, one end of said spoke is stamped by a first stamping unit to form the initial head and neck;
clamp forming, the head, neck and main body of spoke of the initial formed spoke are clamped by a clamping die, the shape of the reinforced part is forged during clamping;
second forging, the spoke clamped by the same clamping die is stamped by a second stamping unit, so as to form the final head, neck and reinforced part;
hobbing, the end opposite to the head of said spoke is hobbed to form a thread part.

2. The spoke reinforcing method defined in claim 1, a bending step can be created between the second forging and hobbing steps to bend the neck of the formed spoke.

3. The spoke reinforcing method defined in claim 1, wherein the cross-sectional shape of the reinforced part is any one of polygons.

4. The spoke reinforcing method defined in claim 1, wherein the cross-sectional shape of the reinforced part is hexagonal or rectangular.

5. The spoke reinforcing method defined in claim 1, wherein the length of the reinforced part is at least 5 mm.

6. A reinforced structure of spokes, including a main body of spoke, a head, a neck and a reinforced part are arranged in turn from the edge of one end of the main body of spoke, the other end is provided with a thread part.

7. The reinforced structure of spokes defined in claim 6, wherein the cross-sectional shape of the reinforced part is hexagonal or rectangular.

8. The reinforced structure of spokes defined in claim 6, wherein the spoke forms include straight-pull spoke and elbow spoke.
